(19) United States
(12) Patent Application Publication
(10) Pub. No.: US 2025/0156313 A1
(43) Pub. Date: May 15, 2025

(54) Optimizations For Payload Fetching In NVMe Commands

(71) Applicant: Western Digital Technologies, Inc., San Jose, CA (US)

(72) Inventors: Judah Gamliel HAHN, Ofra (IL); Shay BENISTY, Beer Sheva (IL); Ariel NAVON, Revava (IL); Alexander BAZARSKY, Holon (IL)

(73) Assignee: Western Digital Technologies, Inc., San Jose, CA (US)

(21) Appl. No.: 18/505,292

(22) Filed: Nov. 9, 2023

(51) Int. Cl. G06F 12/02

(52) U.S. Cl. CPC G06F 12/0246

(57) ABSTRACT

Instead of a system that does not address host buffer fragmentation or saturation, utilize a different metric for command prioritization. Commands are re-ordered and prioritized based on the number of outstanding host buffers that will be released on command completion, thereby limiting and/or reducing the physical address fragmentation and host memory overhead. Command processing priority will take the number of host memory page segments represented by the command into consideration.

### BACKGROUND OF THE DISCLOSURE

### Field of the Disclosure

Embodiments of the present disclosure generally relate to optimizing payload fetching in Non-volatile memory express (NVMe) devices.

### Description of the Related Art

NVMe over peripheral component interconnect express (PCIe) utilizes physical region pages (PRPs) and scatter gather lists (SGLs) for command payload specification. SGLs (Scatter-gather lists) are a collection of host memory addresses that are used for read and write operations. PRPs are a specialized form of SGL, in which each record on the list is a single page of host memory. Host memory addresses supplied to a PCIe device must remain fixed until the command is complete and cannot be relocated while commands are outstanding. This requirement can impact host memory management if there are a large number of outstanding commands, since the affected pages cannot be moved meanwhile.

In storage intensive workloads, this can lead to memory fragmentation and reduce host side performance. Further, some hosts have limitations or optimizations relating to how PCIe devices access certain areas of host memory. For example, security processing on the host may restrict PCIe access to only known memory address ranges, ensuring that a rogue PCIe device does not access system memory via DMA. In multi-processor environments, a switch or memory mapping unit may transfer certain memory addresses to specific physical memory devices, with higher latency or a narrower bus. Current methods for command management optimization focus on throughput and bandwidth, or on latency of an individual command. However, the current methods do not address host buffer fragmentation or saturation.

PCIe devices and NVMe devices use host memory for operational buffers, including queues, PRP lists, and command payloads. As these buffers need to be accessed via PCIe, they are typically allocated with a fixed location in host memory and cannot be relocated while commands are outstanding. In a storage-intensive workloads, this can lead to memory fragmentation and reduce host-side performance. In addition, input-output memory management unit (IOMMU) tracking of these buffers to ensure security can lead to considerable overhead on the host side.

There is a need in the art for improving metrics for command prioritization.

### SUMMARY OF THE DISCLOSURE

Instead of a system that does not address host buffer fragmentation or saturation, utilize a different metric for command prioritization. Commands are re-ordered and prioritized based on the number of outstanding host buffers that will be released on command completion, thereby limiting and/or reducing the physical address fragmentation and host memory overhead. Command processing priority will take the number of host memory page segments represented by the command into consideration.

In one embodiment, a data storage device comprises: a memory device, and a controller coupled to the memory device, wherein the controller is configured to: evaluate commands in one or more submission queues (SQs); select commands in the one or more SQs based upon number of buffers in physical region page (PRP) lists; and prioritize selected commands for processing during arbitration. The one or more SQs comprise a plurality of SQs.

In another embodiment, a data storage device comprises: a memory device; and a controller coupled to the memory device, wherein the controller is configured to: evaluate outstanding commands in one or more submission queues (SQs); select eligible write commands with a highest number of buffers in physical region page (PRP) lists; determine whether there is available memory in a host memory buffer (HMB) to cache write commands; and copy command payload buffers into the HMB.

In another embodiment, a data storage device comprises: means to store data; and a controller coupled to the means to store data, wherein the controller is configured to: evaluate first chunks of commands in one or more submission queues (SQs); determine a ratio of fragments per transfer size for each of the first chunks; select commands in the one or more SQs based upon the ratio; and prioritize selected commands for processing during arbitration.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a block diagram illustrating a system for a simplified NVMe host device interface, according to certain embodiments.

FIG. 3 is a block diagram illustrating a system for PRP list layouts, according to certain embodiments.

FIG. 4 is a block diagram illustrating a system for submission queues (SQ) with varying command sizes, according to certain embodiments.

FIG. 5 is a block diagram illustrating a system for an internal queue, according to certain embodiments.

FIG. 6 is a flowchart illustrating a method for command processing priority, according to certain embodiments.

FIG. 7 is a flowchart illustrating a method for host memory buffer (HMB) caching of fragmented writes, according to certain embodiments.

FIG. 8 is a flowchart illustrating a method for a host command utilizing the PRP lists, according to certain embodiments.

FIG. 9 is a flowchart illustrating a method for a host command utilizing the SGL lists, according to certain embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Instead of a system that does not address host buffer fragmentation or saturation, utilize a different metric for command prioritization. Commands are re-ordered and prioritized based on the number of outstanding host buffers that will be released on command completion, thereby limiting and/or reducing the physical address fragmentation and host memory overhead. Command processing priority will take the number of host memory page segments represented by the command into consideration.

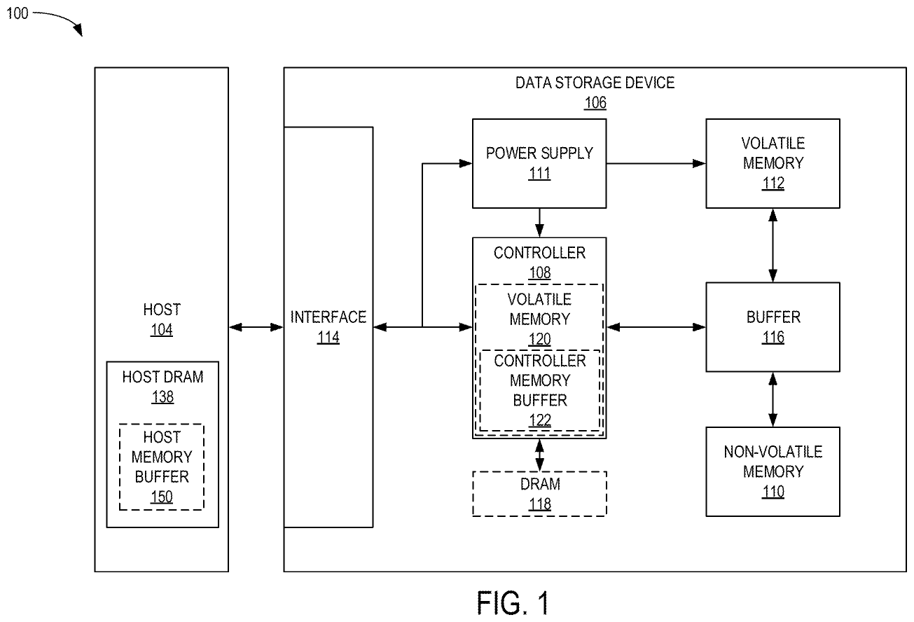

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. It is contemplated that the volatile memory 112 and the DRAM 118 may, in some embodiments, be one in the same. However, it is contemplated that the volatile memory 112 and the DRAM 118 may in fact be different volatile memories with the DRAM 118 being a specific type of volatile memory. As will be discussed below, a second volatile memory 120, which may be SRAM, could also be one in the same with the write buffer 116. However, it is contemplated that there could be distinct DRAM, SRAM, and write buffer. In other words, it is contemplated that there may be multiple distinct volatile memories. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: PCIe, non-volatile memory express (NVMe), OpenCAPI, GenZ, Cache Coherent Interface Accelerator (CCIX), Open Channel SSD (OCSSD), Compute Express Link (CXL), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

As will be discussed herein, re-ordering and prioritizing commands based on the number of outstanding host buffers is discussed with an aim to limit and/or reduce physical address fragmentation and host memory overhead.

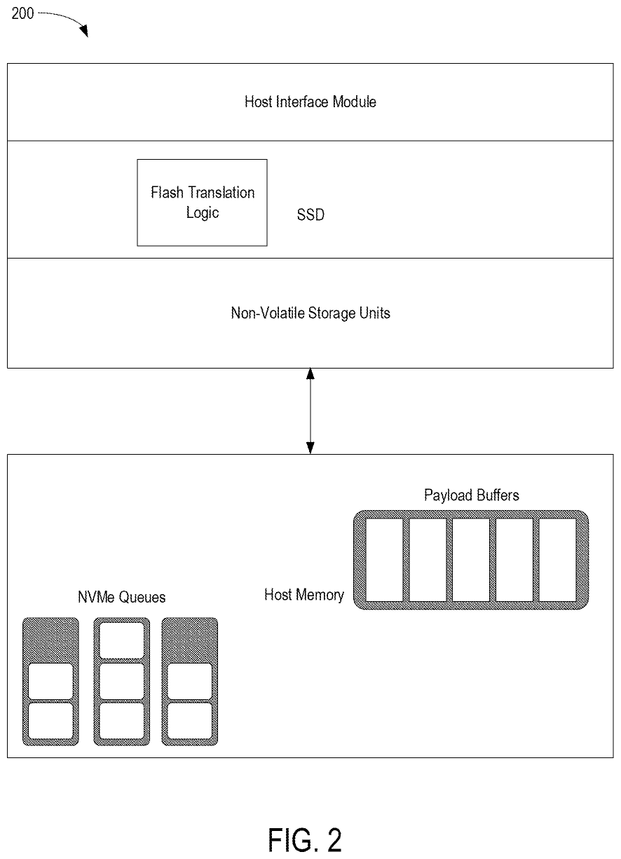

FIG. 2 is a block diagram illustrating a system 200 for a simplified NVMe host device interface, according to certain embodiments. The system 200 comprises a solid state drive (SSD) and a host memory. The SSD comprises a host interface module (HIM), a flash translation logic, a non-volatile storage units. The host memory comprises NVMe queues, which hold commands and command completion notifications. For each I/O command outstanding, there is also one or more payload buffers as indicated in the command parameters. In worst case, there will be one memory page buffer for each page indicated each command.

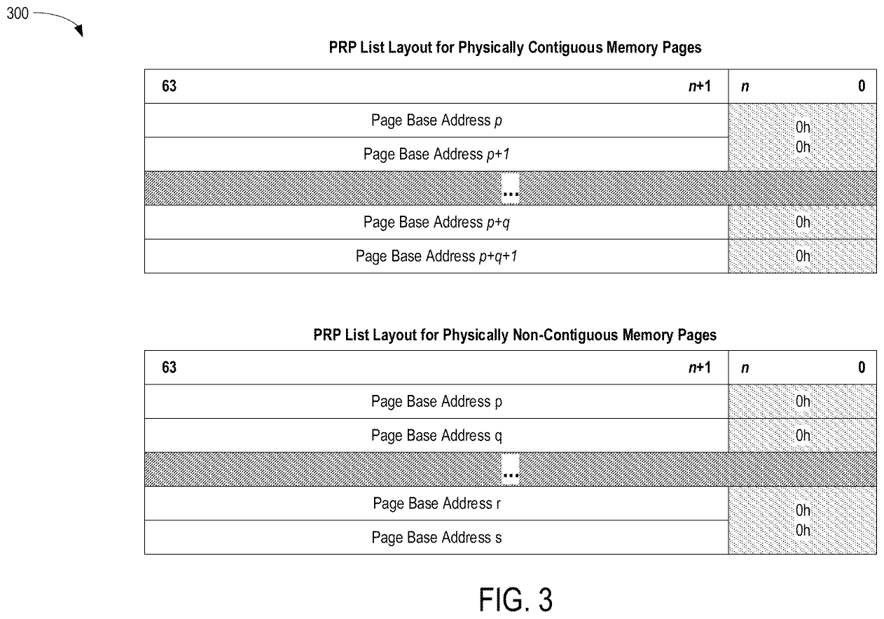

FIG. 3 is a block diagram illustrating a system 300 for PRP list layouts, according to certain embodiments. There are two types of pages that the PRP list layouts are used for. The first type being for physically contiguous pages and the second type beings for non-contiguous memory pages. Commands are processed in NVMe by fetching submission queue entries (SQEs) from queues and feeding them into an internal queue, which is then processed internally. Typically, SQEs are fetched using round robin or weighted round robin arbitration, and may be completed out of order. Various techniques exist in the art for optimizing and coalescing commands based on pipeline optimization.

In some architectures, an intermediate buffer is used for command payloads. For example, an NVMe over fabric (NVMeOF) bridge may have local DRAM which is used to hold the payloads of outstanding commands. Alternatively, a device side controller memory buffer (CMB) may be used to hold command payloads.

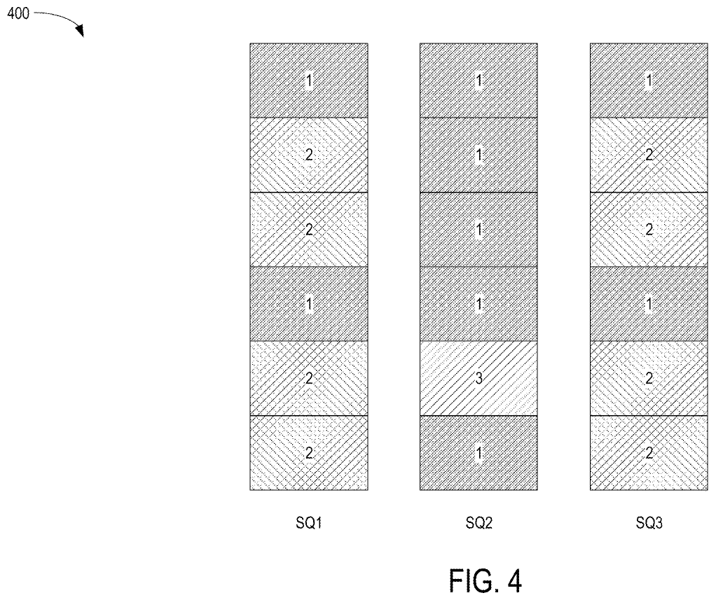

FIG. 4 is a block diagram illustrating a system 400 for SQs with varying command sizes, according to certain embodiments. The system 400 comprises a SQ1, SQ2, and SQ3. Each box in the SQs represents a read command SQE, and the payload sizes are as follows. The shaded commands (labeled 1) are 4 KB in size. The checkered commands (labeled 2) are 512 KB in multiple buffers. The striped command (labeled 3) is 512 KB in a single buffer. It is assumed, for exemplification purposes, that the page size is 4 KB. As will be discussed below, different metrics are focused on for command prioritization. The commands are prioritized based on the number of host buffers outstanding which will be released when the command is completed.

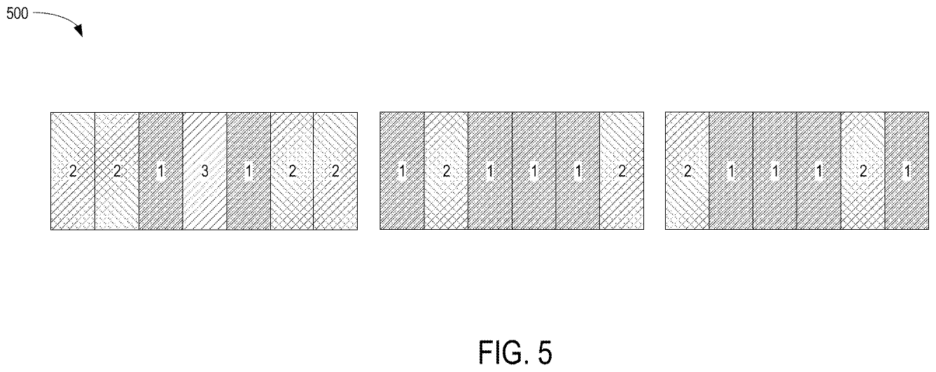

FIG. 5 is a block diagram illustrating a system 500 for an internal queue, according to certain embodiments. In classic round-robin arbitration, the arbitration burst size indicates the number of SQEs fetched from the host in each arbitration round. Rounds continue until the device-internal queue is full, and then resume when commands are completed. Assuming an arbitration burst size of 2, the internal device queue most systems will resemble the system 500.

Once commands are in the internal queue, the commands are typically completed out of order. As a command is processed, the command may be broken down into smaller portions which are completed individually. The host is then notified once the entire command is complete. As represented here, the 4 KB commands will complete quickly, but each will release a single buffer. The striped command (labeled 3) may complete after other commands, potentially fragmenting host memory.

Command processing priority will take the number of host memory page segments represented by the command into consideration. For example, a 512 KB read command may represent a single sequential buffer in host memory, or the 512 KB read command may represent 128 individual pages that are not connected. The prioritization engine discussed herein will prioritize the fragmented command higher than a command representing a single extent in host memory, thus reducing overhead.

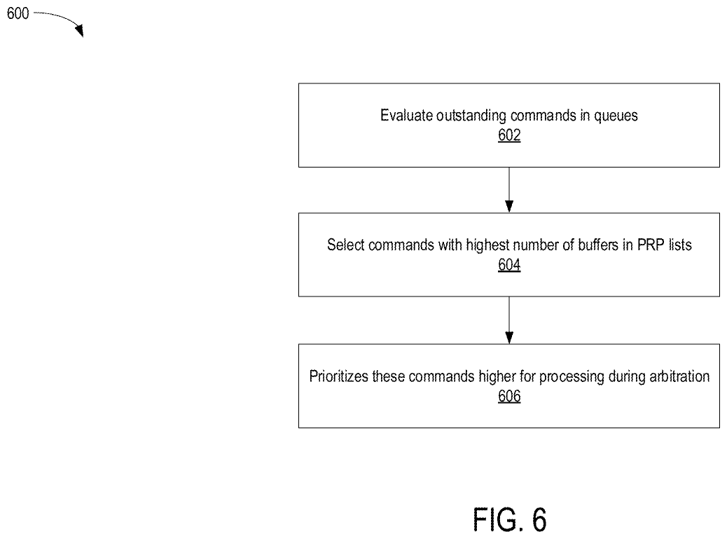

FIG. 6 is a flowchart illustrating a method 600 for command processing priority, according to certain embodiments. Other considerations may affect actual command processing order in addition to this one. An actual device implementation may employ multiple weights in order to ensure throughput and reasonable quality of service. The method 600 begins at block 602. At block 602, the controller evaluates outstanding commands in queues. At block 604, the controller selects commands with highest number of buffers in PRP lists. At block 606, the controller prioritizes the commands higher for processing during arbitration.

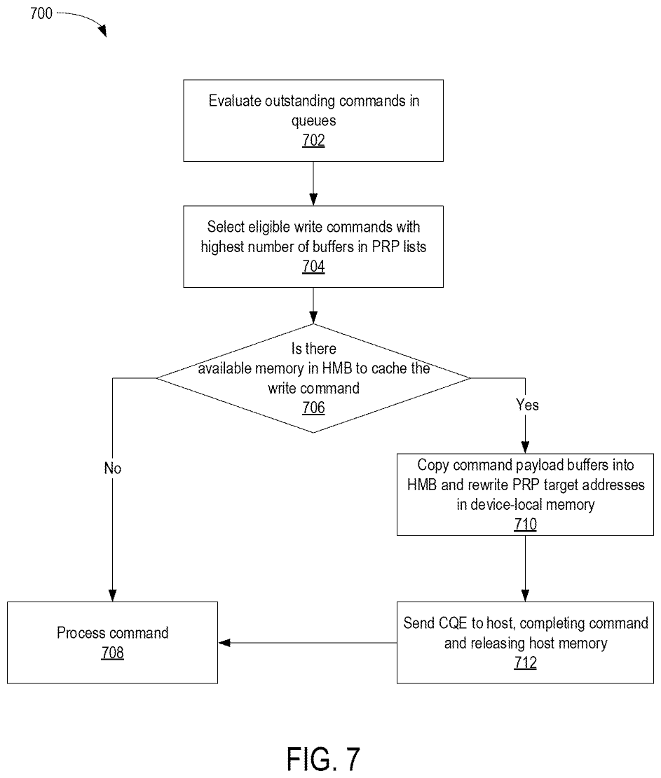

FIG. 7 is a flowchart illustrating a method 700 for HMB caching of fragmented writes, according to certain embodiments. Write commands with heavily fragmented payload buffers may be moved into the HMB as part of a pre-processing operation. Moving the buffers as a part of pre-processing operation apply to write commands that meet certain criteria. For example, if the command has the force unit access (FUA) flag set, then the command cannot be cached in the HMB. Furthermore, devices without a volatile write cache cannot employ this technique, since the HMB is not protected against power failures.

The method 700 begins at block 702. At block 702, the controller evaluates outstanding commands in queues. At block 704, the controller selects eligible write commands with highest number of buffers in PRP lists. At block 706, the controller determines whether there is available memory in HMB to cache the write command. If the controller determines that there is no available memory in the HMB cache, then the method 700 proceeds to block 708. At block 708, the controller processes the command. If the controller determines that there is available memory in the HMB cache, then the method 700 proceeds to block 710. At block 710, the controller copies command payload buffers into HMB and rewrite PRP target addresses in device-local memory. At block 712, the controller sends a completion queue entry (CQE) to the host, completing command and releasing host memory.

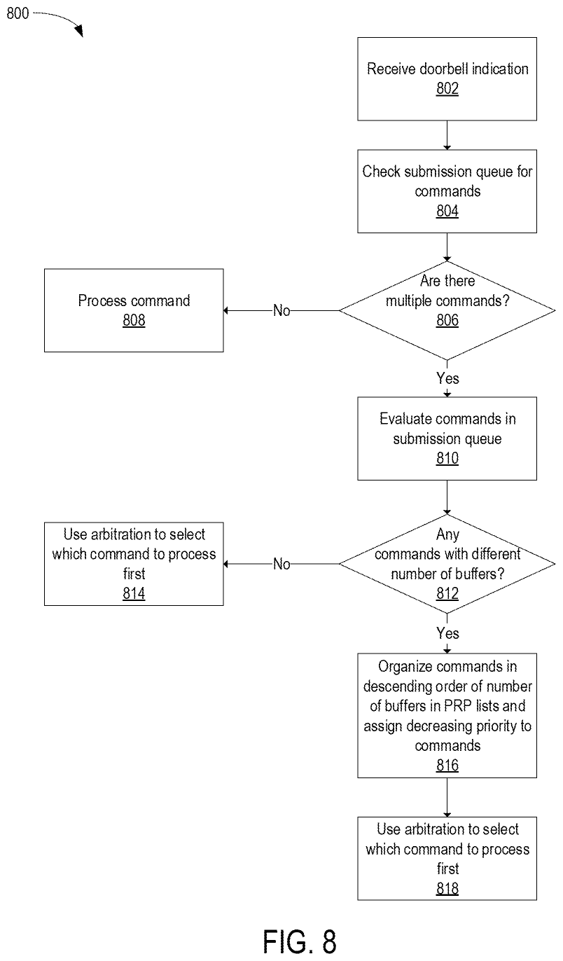

FIG. 8 is a flowchart illustrating a method 800 for a host command utilizing the PRP list, according to certain embodiments. Some host commands may discard part of a command payload, by using the same address more than once. This technique can be used to coalesce read commands in neighboring LBA ranges. Commands with the same address repeated multiple times in the PRP list would be excluded from this optimization.

The method 800 begins at block 802. At block 802, the controller receives a doorbell indication. At block 804, the controller checks submission queue for commands. At block 806, the controller determines whether there are multiple commands. If the controller determines that there are not multiple commands, then the method 800 proceeds to block 808. At block 808, the controller processes the command. If the controller determines that there are multiple commands, then the method 800 proceeds to block 810. At block 810, the controller evaluates commands in submission queue.

At block 812, the controller determines whether there are any commands with different number of buffers. If the controller determines that there are not any commands with different number of buffers, then the method 800 proceeds to block 814. At block 814, the controller uses arbitration to select which command to process first. If the controller determines that there are commands with different number of buffers, then the method 800 proceeds to block 816. At block 816, the controller organizes commands in descending order of number of buffers in PRP lists and assign decreasing priority to commands. At block 818, the controller uses arbitration to select which command to process first.

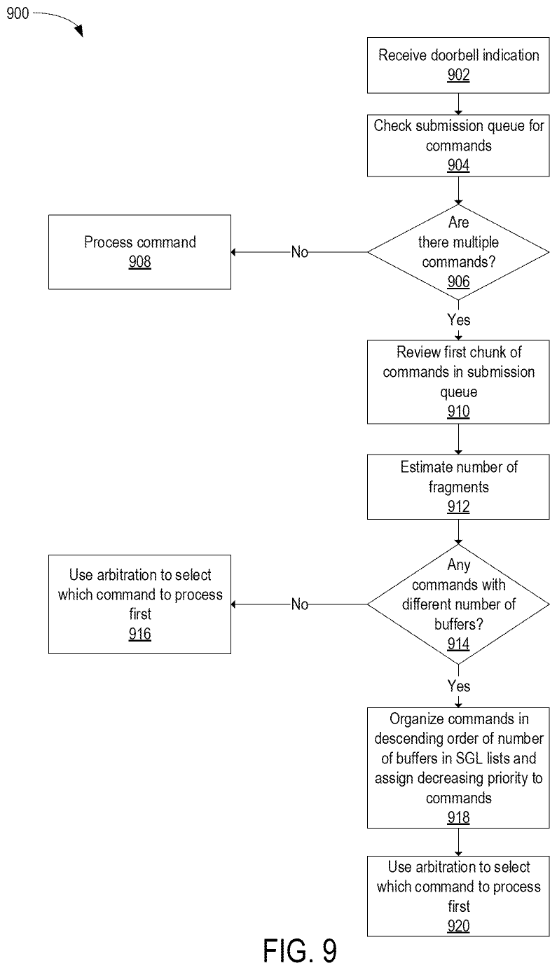

FIG. 9 is a flowchart illustrating a method 900 for a host command utilizing the SGL lists, according to certain embodiments. In this case, the detection number of fragments utilized by each outstanding command is difficult since usually the SGL segments are held in the host memory and not fetched ahead of time. In order to estimate the number of fragments utilized by each outstanding command, the device may take a prediction approach. The approach is including looking on the first chunk of the commands and the first SGL segments and having the assumption that the rest of the command will keep the same ratio of fragments per transfer size.

The method 900 begins at block 902. At block 902, the controller receives a doorbell indication. At block 904, the controller checks a submission queue for commands. At block 906, the controller determines whether there are multiple commands. If the controller determines that there are not multiple commands, then the method 900 proceeds to block 908. At block 908, the controller processes the command. If the controller determines that there are multiple commands, then the method 900 proceeds to block 910. At block 910, the controller reviews first chunk of commands in the submission queue. At block 912, the controller estimates number of fragments.

At block 914, the controller determines whether there are any commands with different number of buffers. If the controller determines that there are not any commands with different number of buffers, then the method 900 proceeds to block 916. At block 916, the controller uses arbitration to select which command to process first. If the controller determines that there are commands with different number of buffers, then the method 900 proceeds to block 918. At block 918, the controller organizes commands in descending order of number of buffers in SGL lists and assign decreasing priority to commands. At block 920, the controller uses arbitration to select which command to process first.

By reordering and prioritizing commands in workloads that stress host physical memory, the device will reduce swapping and I/O contention without impacting overall throughput.

In one embodiment, a data storage device comprises: a memory device, and a controller coupled to the memory device, wherein the controller is configured to: evaluate commands in one or more submission queues (SQs); select commands in the one or more SQs based upon number of buffers in physical region page (PRP) lists; and prioritize selected commands for processing during arbitration. The one or more SQs comprise a plurality of SQs. The evaluating comprises determining a payload size of the commands. The prioritizing comprises placing the selected commands into an internal SQ prior to placing non-selected commands into the internal SQ. At least one selected command is fragmented. At least one selected command represents a buffer having a size greater than a page size. The buffer is a single sequential buffer. The controller is configured to process a command of the prioritized selected command, wherein the prioritized selected command is broken down into smaller portions. The smaller portions are completed individually. The controller is configured to notify a host device after processing of all smaller portions is complete.

In another embodiment, a data storage device comprises: a memory device; and a controller coupled to the memory device, wherein the controller is configured to: evaluate outstanding commands in one or more submission queues (SQs); select eligible write commands with a highest number of buffers in physical region page (PRP) lists; determine whether there is available memory in a host memory buffer (HMB) to cache write commands; and copy command payload buffers into the HMB. The eligible write commands do not have a force unit access (FUA) flag set. Further comprising a volatile write cache. The controller is further configured to rewrite PRP target addresses after the copying. The controller is further configured to send a completion queue (CQ) entry to a host device after the copying. The controller is configured to release host memory after the copying and rewriting. The controller is configured to process commands after sending the CQ entry.

In another embodiment, a data storage device comprises: means to store data; and a controller coupled to the means to store data, wherein the controller is configured to: evaluate first chunks of commands in one or more submission queues (SQs); determine a ratio of fragments per transfer size for each of the first chunks; select commands in the one or more SQs based upon the ratio; and prioritize selected commands for processing during arbitration. The commands are scatter gather lists (SGLs). The controller is configured to assume a rest of a command will maintain the ratio.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
evaluate commands in one or more submission queues (SQs);
select commands in the one or more SQs based upon number of buffers in physical region page (PRP) lists; and
prioritize selected commands for processing during arbitration.

2. The data storage device of claim 1, wherein the one or more SQs comprise a plurality of SQs.

3. The data storage device of claim 1, wherein the evaluating comprises determining a payload size of the commands.

4. The data storage device of claim 1, wherein the prioritizing comprises placing the selected commands into an internal SQ prior to placing non-selected commands into the internal SQ.

5. The data storage device of claim 1, wherein at least one selected command is fragmented.

6. The data storage device of claim 1, wherein at least one selected command represents a buffer having a size greater than a page size.

7. The data storage device of claim 6, wherein the buffer is a single sequential buffer.

8. The data storage device of claim 1, wherein the controller is configured to process a command of the prioritized selected command, wherein the prioritized selected command is broken down into smaller portions.

9. The data storage device of claim 8, wherein the smaller portions are completed individually.

10. The data storage device of claim 9, wherein the controller is configured to notify a host device after processing of all smaller portions is complete.

11. A data storage device, comprising:
a memory device; and
a controller coupled to the memory device, wherein the controller is configured to:
evaluate outstanding commands in one or more submission queues (SQs);
select eligible write commands with a highest number of buffers in physical region page (PRP) lists;
determine whether there is available memory in a host memory buffer (HMB) to cache write commands; and
copy command payload buffers into the HMB.

12. The data storage device of claim 11, wherein the eligible write commands do not have a force unit access (FUA) flag set.

13. The data storage device of claim 11, further comprising a volatile write cache.

14. The data storage device of claim 11, wherein the controller is further configured to rewrite PRP target addresses after the copying.

15. The data storage device of claim 14, wherein the controller is further configured to send a completion queue (CQ) entry to a host device after the copying.

16. The data storage device of claim 15, wherein the controller is configured to release host memory after the copying and rewriting.

17. The data storage device of claim 16, wherein the controller is configured to process commands after sending the CQ entry.

18. A data storage device, comprising:
means to store data; and
a controller coupled to the means to store data, wherein the controller is configured to:
evaluate first chunks of commands in one or more submission queues (SQs);
determine a ratio of fragments per transfer size for each of the first chunks;
select commands in the one or more SQs based upon the ratio; and
prioritize selected commands for processing during arbitration.

19. The data storage device of claim 18, wherein the commands are scatter gather lists (SGLs).

20. The data storage device of claim 18, wherein the controller is configured to assume a rest of a command will maintain the ratio.
